(19) United States
(12) Patent Application Publication
(10) Pub. No.: US 2026/0254925 A1
(43) Pub. Date: Aug. 27, 2026

(54) COMMUNICATION ASSISTANCE PROGRAM, COMMUNICATION ASSISTANCE METHOD, AND COMMUNICATION ASSISTANCE SYSTEM

(71) Applicant: Sumitomo Electric Industries, Ltd., Osaka-shi, Osaka (JP)

(72) Inventors: Toshiaki KAKII, Osaka-shi, Osaka (JP); Guiming DAI, Osaka-shi, Osaka (JP)

(73) Assignee: Sumitomo Electric Industries, Ltd., Osaka-shi, Osaka (JP)

(21) Appl. No.: 18/861,674

(22) PCT Filed: Nov. 6, 2023
(86) PCT No.: PCT/JP2023/039937

§ 371 Date: Oct. 30, 2024

(30) Foreign Application Priority Data
May 17, 2023 (JP) 2023-081344

(51) Int. Cl. H04N 7/15; G06F 3/0486

(52) U.S. Cl. CPC H04N 7/157; G06F 3/0486

(57) ABSTRACT

A communication assistance program is a communication assistance program for assisting communication between a plurality of characters in a virtual space, wherein an object on which one or a plurality of the characters are located is displayed integrally with one or a plurality of the characters, and the plurality of characters located on the one object are enabled to converse with each other.

### TECHNICAL FIELD

An aspect of the present disclosure relates to a communication assistance program, a communication assistance method, and a communication assistance system.

The present application is based upon and claims the benefit of priority from Japanese Patent Application No. 2023-081344, filed May 17, 2023, the entire content of which is incorporated herein by reference.

### BACKGROUND ART

In recent years, Teams (registered trademark), Zoom (registered trademark), and the like have become the mainstream in remote communication. In remote communication, participants are set and invited in advance, and when a predetermined time has elapsed, the participants access the WEB or the like to carry out communication such as a conference. Non-Patent Literature 1 discloses Teams as remote communication.

### CITATION LIST

### Patent Literature [Non-Patent Literature 1] “Microsoft Teams,” [online], Microsoft, [accessed on May 10, 2023], the Internet, <URL:https://www.microsoft.com/ja-jp/microsoft-teams/group-chat-software>

### SUMMARY OF INVENTION

A communication assistance program according to an embodiment of the present disclosure is a communication assistance program for assisting communication between a plurality of characters in a virtual space, wherein an object on which one or a plurality of the characters are located is displayed integrally with one or a plurality of the characters, and the plurality of characters located on the one object are enabled to converse with each other.

### BRIEF DESCRIPTION OF DRAWINGS

FIG. 1 is a diagram illustrating an example of a schematic configuration of a display system according to an embodiment.

FIG. 2 is a diagram illustrating an example of functional blocks of a terminal and a server.

FIG. 3 is a perspective view of an operation device.

FIG. 4 is a diagram illustrating an example of a functional block of the operation device shown in FIG. 3.

FIG. 5 is a diagram illustrating an example of operations of ear animation.

FIG. 6 is a diagram illustrating an example of a screen displayed in a virtual space.

FIG. 7 is a diagram illustrating an example of a screen displayed in a virtual space.

FIG. 8 is a diagram illustrating an example of a screen displayed in a virtual space.

FIG. 9 is a diagram illustrating an example of a screen displayed in a virtual space.

FIG. 10 is a diagram illustrating an example of a screen displayed in a virtual space.

FIG. 11 is a diagram illustrating an example of a screen displayed in a virtual space.

FIG. 12 is a diagram illustrating an example of a screen displayed in a virtual space.

FIG. 13 is a diagram illustrating an example of a screen displayed in a virtual space.

FIG. 14 is a diagram illustrating an example of a screen displayed in a virtual space.

FIG. 15 is a diagram illustrating an example of a screen displayed in a virtual space.

FIG. 16 is a diagram illustrating an example of a screen displayed in a virtual space.

FIG. 17 is a diagram illustrating an example of a screen displayed in a virtual space.

FIG. 18 is a diagram illustrating an example of a screen displayed in a virtual space.

FIG. 19 is a diagram illustrating an example of a screen displayed in a virtual space.

FIG. 20 is a diagram illustrating an example of a screen displayed in a virtual space.

FIG. 21 is a diagram illustrating an example of a screen displayed in a virtual space.

FIG. 22 is a diagram illustrating an example of a screen displayed in a virtual space.

FIG. 23 is a diagram illustrating an example of a screen displayed in a virtual space.

### DESCRIPTION OF EMBODIMENTS

### Problem to be Solved by the Present Disclosure

In the above remote communication, although it is possible to perform communication such as conversations with members who are set as participants, conversations with communication partners who are not specified in advance, such as so-called casual chatting, are difficult to generate accidentally or spontaneously. For example, people in places where people actually gather (such as party venues, smoking rooms, free spaces, tea rooms (kitchenettes), break rooms, dining halls, or hallways) naturally engage in casual chatting. In places where people actually gather, conversing individuals nod or respond to each other while looking at each other's faces, and thus by observing these subtle changes in facial expressions, it is possible to ascertain the conversation situation of the conversing individuals and to recognize a conversation group. This makes it possible to watch the state of the conversing individual, and at the right moment, to speak to the conversing individual, so that casual chatting is naturally generated.

In a virtual space such as the metaverse which is one type of remote communication, a character (avatar) can move freely within the virtual space and communicate with other characters. Therefore, casual chatting or the like may occur between characters. However, it is not easy to perform casual chatting within the metaverse. This is because in the metaverse, it is difficult to accurately express nonverbal information such as character's gazes and conversational reactions, which makes it difficult to ascertain the situation between characters and to recognize conversation groups such as which characters are talking.

An object of the present disclosure is to provide a communication assistance program, a communication assistance method, and a communication assistance system that make it possible to easily generate communication between characters in a virtual space.

### Effects of the Present Disclosure

According to the present disclosure, it is possible to easily generate communication between characters in a virtual space.

### Description of Embodiment of the Present Disclosure

First, the content of the embodiment according to the present disclosure will be listed and described. At least some of the embodiment to be described below may be arbitrarily combined.
(1) According to an aspect of the present disclosure, there is provided a communication assistance program for assisting communication between a plurality of characters in a virtual space, wherein an object on which one or a plurality of the characters are located is displayed integrally with one or a plurality of the characters, and the plurality of characters located on the one object are enabled to converse with each other.

The communication assistance program according to an aspect of the present disclosure allows a plurality of characters to converse with each other in a case where the characters are located on one object. That is, a conversation is established between the characters located on one object. Therefore, it is possible to ascertain at a glance which characters are conversing with each other. In other words, it is possible to ascertain at a glance which characters are not conversing. In this way, the communication assistance program makes it possible to visualize the state of communication. Therefore, the communication assistance program makes it possible to offer casual chatting to the characters, for example, in a case where no communication is taking place. Therefore, the communication assistance program makes it possible to naturally generate casual chatting and the like. As a result, the communication assistance program makes it possible to easily generate communication between the characters in the virtual space.
(2) In the communication assistance program of the above (1), in a case where an operation of associating any of one or a plurality of the characters with another character different from the character is accepted, the object on which any of the characters has been located and the object on which the other character has been located may be integrated, and any of the characters and the other character may be positioned on the integrated single object. In this configuration, the plurality of characters can be positioned on one object by performing an operation of associating any character with another character. In addition, the sense of unity of conversation is improved by integrating the objects.
(3) In the communication assistance program of the above (2), in a case where the association operation is accepted, a user of the other character may be prompted to select whether to permit a conversation, in a case where the user of the other character permits the conversation, the object on which any of the characters has been located and the object on which the other character has been located may be integrated, and any of the characters and the other character may be positioned on the integrated single object, and in a case where the user of the other character rejects the conversation, the association operation may be invalidated. In this configuration, the user of the character can select whether to have a conversation.
(4) In the communication assistance program of the above (2) or (3), the association operation may be an operation of dragging and dropping any of the characters or the object on which the character is located onto the other character or the object on which the character is located. In this configuration, a plurality of characters can be positioned on one object by a simple drag-and-drop operation. In addition, by providing a drag-and-drop participation transition process, a user who operates the character can prepare himself or herself mentally, making it possible to feel more natural.
(5) In the communication assistance program of any one of the above (2) to (4), in a case where an operation of ending a conversation of one or a plurality of the characters is accepted with the plurality of characters located on the one object, the object may be newly displayed and one or a plurality of the characters who have ended the conversation may be positioned on the newly displayed object. In this configuration, when the conversation ends, the character who has ended the conversation can be positioned on the object again.
(6) In the communication assistance program of the above (5), the operation of ending the conversation may be an operation of dragging and dropping one or a plurality of the characters from the object to the outside. In this configuration, a conversation can be ended by a simple drag-and-drop operation.
(7) In the communication assistance program of any one of the above (1) to (6), the object may be movable in the virtual space. In this configuration, the character located on the object can be moved in the virtual space.
(8) In the communication assistance program of any one of the above (1) to (7), communication between the character located on the object and the character not located on the object may be enabled. In this configuration, it is possible to confirm in advance, for example, whether the character located on the object is available for participation in the conversation.
(9) In the communication assistance program of any one of the above (1) to (8), information related to participation in a conversation may be displayed on the object. In this configuration, it is possible to ascertain at a glance whether the object is available for participation in the conversation, the degree to which participation in the conversation is possible, and the like.
(10) In the communication assistance program of any one of the above (1) to (9), in a case where one or a plurality of the characters are located on the one object, the character may be automatically moved to a predetermined location when a predetermined time has elapsed or a predetermined operation is accepted. In this configuration, it is possible to end a conversation in one object and to automatically gather the characters at a predetermined location (such as a meeting place).
(11) In the communication assistance program of any one of the above (1) to (10), at least one of the plurality of characters located on the one object may be operated by AI.
(12) In the communication assistance program of the above (1), the object on which any of one or a plurality of the characters has been located and the object on which the other character different from the character has been located may be automatically integrated, and any of the characters and the other character may be positioned on the integrated single object. In this configuration, it is possible to automatically position a plurality of characters on one object. That is, it is possible to automatically match the characters. This makes it possible to not only communicate with a specific character (user), but also communicate with a new character.
(13) In the communication assistance program of the above (12), in a case where a predetermined time has elapsed with the plurality of characters located on the one object, the object may be newly displayed and one or a plurality of the characters who have ended a conversation may be positioned on the newly displayed object. In this configuration, the conversation is ended after a predetermined time has elapsed. In this way, since the time of communication is limited, communication with the same character does not drag on for too long. This makes it possible to communicate with many characters.
(14) In the communication assistance program of the above (12) or (13), a display unit that displays information related to conversation content may be caused to display in the one object on which the plurality of characters are located. In this configuration, for example, the topic of the conversation is displayed (provided) on the display unit as information related to the conversation content, which makes it possible to carry out communication smoothly.
(15) In the communication assistance program of the above (13), information related to the predetermined time may be displayed in the one object on which the plurality of characters are located. In this configuration, for example, the remaining time of a predetermined time or the like can be confirmed, which makes it possible to carry out communication in consideration of time allocation (end time).
(16) In the communication assistance program of any one of the above (12) to (15), the character operated by a facilitator user may be displayed in the virtual space. In this configuration, in a case where the program is applied to meetings in which many users participate (such as, for example, training sessions, information exchange meetings, or social gatherings), the meetings will be conducted by a facilitator, which makes it possible for the meetings to proceed smoothly.
(17) In the communication assistance program of any one of the above (12) to (16), cards containing at least information with which it is possible to identify the user of the character may be able to be exchanged with the plurality of characters located on the one object. In this configuration, after the conversation ends, it is possible to confirm a character (user) with whom the conversation has taken place.
(18) In the communication assistance program of any one of the above (12) to (17), at least one of the plurality of characters located on the one object may be operated by AI.
(19) According to an aspect of the present disclosure, there is provided a communication assistance method of assisting communication between a plurality of characters in a virtual space, the method including: displaying an object on which one or a plurality of the characters are located integrally with one or a plurality of the characters; and enabling the plurality of characters located on the one object to converse with each other.

The communication assistance method according to an aspect of the present disclosure includes the same features as the above-described communication assistance program. This makes it possible to achieve the same operations and effects as the above-described communication assistance program.
(20) According to an aspect of the present disclosure, there is provided a communication assistance system configured to assistance communication between a plurality of characters in a virtual space, wherein an object on which one or a plurality of the characters are located is displayed integrally with one or a plurality of the characters, and the plurality of characters located on the one object are enabled to converse with each other.

The communication assistance system according to an aspect of the present disclosure includes the same features as the above-described communication assistance program. This makes it possible to achieve the same operations and effects as the above-described communication assistance program.

### Details of Embodiment of the Present Disclosure

Specific examples of an embodiment of the present disclosure will be described below with reference to the accompanying drawings. The present disclosure is not limited to these examples, and is defined by the scope of the claims and intended to include all modifications within the meaning and scope of the claims and equivalents. In the description of the drawings, the same elements are denoted by the same reference numerals and signs, and thus redundant descriptions will be omitted.

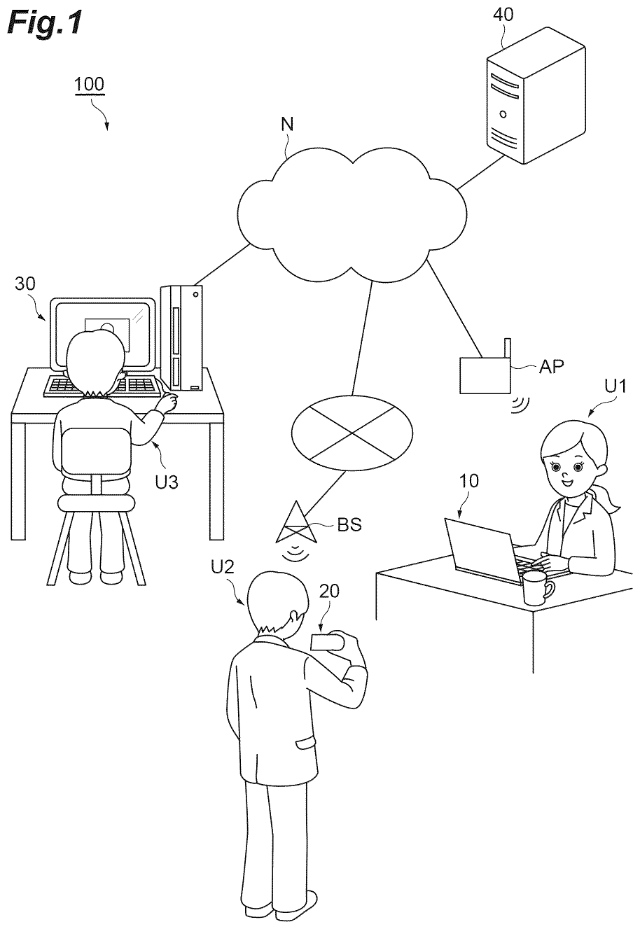

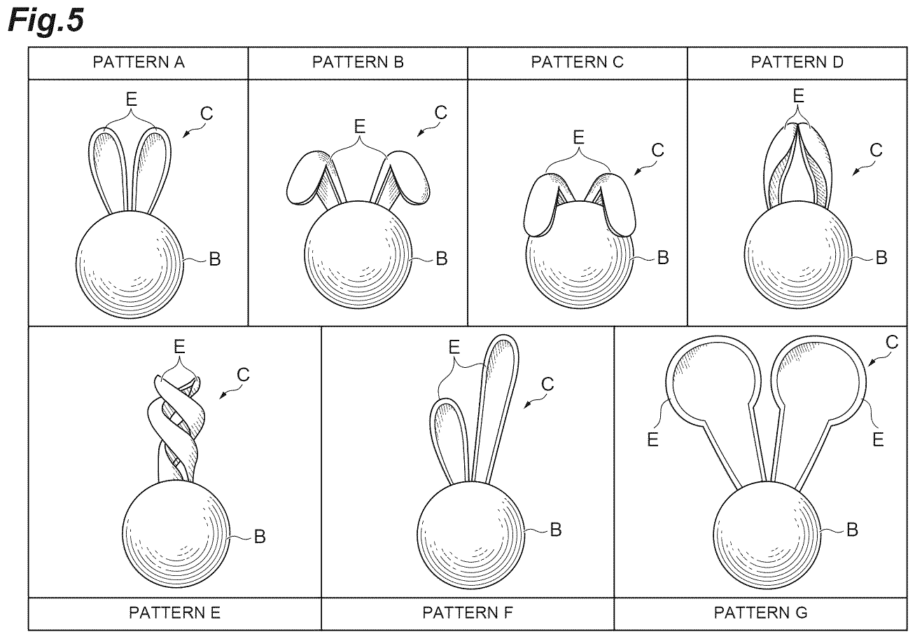

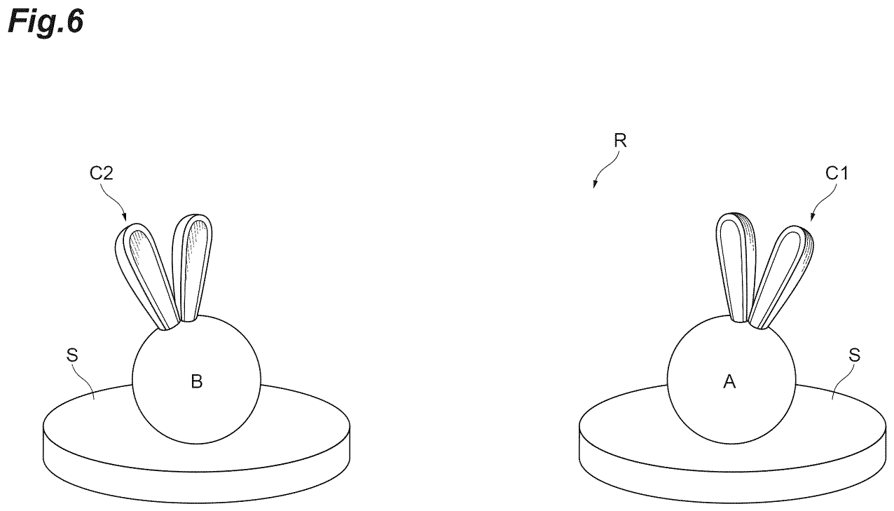

FIG. 1 is a diagram illustrating an example of a schematic configuration of a communication assistance system (hereinafter, sometimes simply referred to as a “system”). A system 100 is a computer system that assistances communication in a virtual space R (see FIG. 6) using a character C (see the pattern A in FIG. 5) that can be operated by a user, and an ear animation E (see the pattern A in FIG. 5) of the character C operates in response to the user's operation.

The character C may be operated by human users U1, U2, and U3, or may be operated by something other than a person. The character C may be operated, for example, by an AI (ChatGPT, Siri (registered trademark), Google Assistant (registered trademark), Alexa (registered trademark), or Cortana (registered trademark)). That is, a user who operates the character C may be an AI. The user is an operator who operates the character C, or the like.

The character C represents a user. The character C is a dynamic character. The character C is generated by image material independent of the user's actual image (such as image capture data). The image material is material used to generate animation characters. The character C may be rendered by two-dimensional or three-dimensional computer graphics (CG).

As an example, the character C is configured to include a body B (see the pattern A in FIG. 5) and an ear animation E. For the character C, the body B and the ear animation E are displayed integrally. Being displayed integrally means that when the character C is viewed, the body B and the ear animation E are visually recognized as a single entity. That is, being displayed integrally need only be a state where the body B and the ear animation E can be recognized at a glance as being connected (corresponding) to each other. Therefore, being displayed integrally may be a state where the body B and the ear animation E are in contact with each other, or may be a state where the body B and the ear animation E are separated from each other.

The body B may include at least one of an image indicating a user and text indicating a user. The character C may have a shadow displayed. The body B has a spherical shape and may contain text (such as “A,” “B,” or “C”) with which a user can be identified. The character C may be configured to include a speaking animation (not shown), or may be configured to include animations that imitate arms, legs, and the like.

The ear animation E is an animation that expresses nonverbal information. The ear animation E is an animation indicating the state (motion) and emotion of a user. The ear animation E is an animation that expresses the state of a user in a form different from the actual moving part of the user. The ear animation E may not include a dynamically changing facial expression, or may include a dynamically changing facial expression. The ear animation E is displayed outside the display region of the body B so as to protrude from the display region. The ear animation E is an animation that imitates the ears of an animal (such as, for example, a rabbit) and operates in response to changes in the user's state. The ear animation E operates in response to the user's motion. The ear animation E performs motions such as, for example, stretching, bending, and swinging. The ear animation E is freely deformable and undergoes visual deformation in response to the user's state in a manner that evokes the user's state.

In the system 100, the user's state, emotion, reaction, and the like can be confirmed through the ear animation E of the character C.

### <Configuration of System>

The system 100 includes a terminal 10, a terminal 20, and a terminal 30. In the example shown in FIG. 1, the terminal 10 is a laptop personal computer (PC) used by a user U1. The terminal 20 is a cellular phone (such as a smartphone) used by a user U2. The terminal 30 is a laptop PC used by a user U3. The terminal 10, the terminal 20, and the terminal 30 can be connected to a network N. In this example, the terminal 10 is connected to the network N through an access point AP, the terminal 20 is connected to the network N through a base station BS, and the terminal 30 is connected to the network N by cable (not shown). In addition to the above-mentioned PC and cellular phone, a tablet terminal, a wearable terminal, a head mounted display (HMD) terminal, and various other terminals may be used for the terminal 10, the terminal 20, and the terminal 30. Meanwhile, the number of terminals included in the system 100 is not limited to the example of FIG. 1.

The system 100 includes a server 40. The server 40 is connected to the network N. Therefore, the terminal 10, the terminal 20, the terminal 30, and the server 40 can communicate with each other through the network N. Meanwhile, the number of servers included in the system 100 is not limited to the example of FIG. 1.

There are no limitations on the configuration of the network N. For example, the network N may be configured to include the Internet (a public network), a communication carrier network, a business network, and the like.

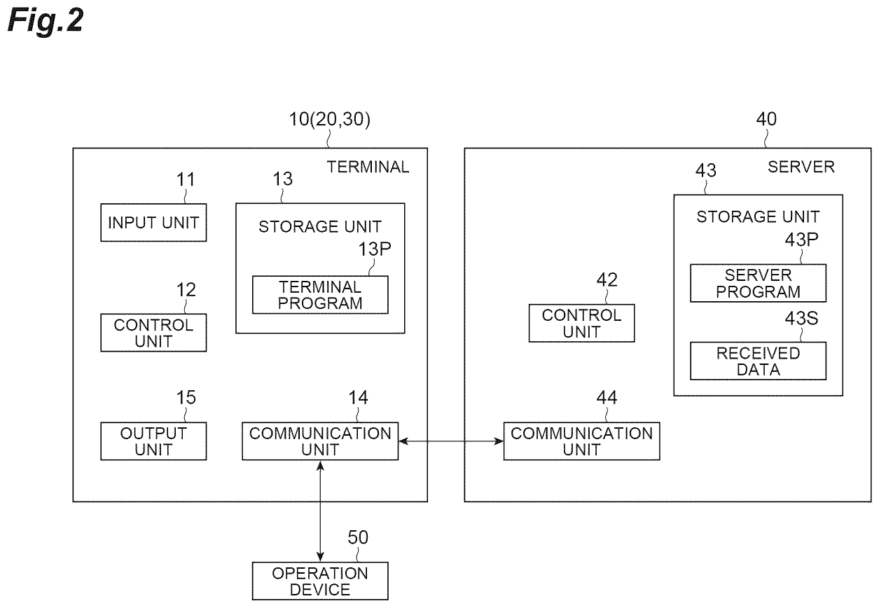

FIG. 2 is a diagram illustrating an example of functional blocks of the terminal 10, the terminal 20, the terminal 30, and the server 40. The functional blocks of the terminal 20 and the terminal 30 are the same as the functional blocks of the terminal 10, and thus the terminal 10 and the server 40 will be described below. First, the terminal 10 will be described, and then the server 40 will be described.

### <Configuration of Terminal>

The terminal 10 includes an input unit 11. The input unit 11 is a portion to which voice data and image data of the user U1 are input. Video data of the user U1 may be input to the input unit 11. The video includes voice data and image data of the user U1.

The terminal 10 includes a control unit 12. The control unit 12 is a portion that generates control data for the user U1. The control data for the user U1 is generated on the basis of motion data output from an operation device 50. In the present embodiment, for example, as control data, data can be generated to cause the ear animation E of the character C to perform six motions: “nodding,” “agreement,” “praise (clap),” “question,” “raising hand,” and “surprise.” The control unit 12 may generate control data for other motions (for example, motions indicating “YES” and “NO”).

The control data is associated with the motion data. In the present embodiment, for example, motion data is associated with each piece of control data of “nodding,” “agreement,” “praise (clap),” “question,” “raising hand,” and “surprise.” The motion data is data which is transmitted from the operation device 50. In a case where the motion data corresponds to the control data, the control unit 12 generates the control data.

The control data may be generated on the basis of the voice data and image data of the user U1 input to the input unit 11. The image data is constituted by a plurality of successive unit frames. The unit frame usually contains image information of the user U1. For example, image data of 60 frames/second contains 60 unit frames per second. The details of the generation of control data performed by the control unit 12 will be described later.

The control unit 12 is also a portion that controls the motion of the character C on the basis of the control data. The control unit 12 displays the character C in the virtual space R and controls the motion of the ear animation E of the character C on the basis of the generated control data and the received control data.

The control unit 12 generates video data of the virtual space R. The video data of the virtual space R includes video data of the character C which is controlled on the basis of the control data. In addition, various objects that appear in the virtual space R may be included in the video data of the virtual space R. A method of generating the virtual space R which is performed by the control unit 12 is not particularly limited, and various known methods can be used. The control unit 12 may generates, for example, video data of the virtual space R on the basis of an image captured by a camera. Alternatively, the control unit 12 may generate video data of the virtual space R on the basis of three-dimensional CAD data.

The terminal 10 includes a storage unit 13. The storage unit 13 is a portion that stores information necessary for controlling (processing) the terminal 10. FIG. 2 illustrates a terminal program 13P as information stored in the storage unit 13. The terminal program 13P is a program for operating the terminal 10, and operates a computer so that the control unit 12 executes control or the like. Since the system 100 is a communication assistance system, the terminal program 13P can also be referred to as a communication assistance program.

The terminal 10 includes a communication unit 14. The communication unit 14 is a portion that communicates with external devices of the terminal 10 through the network N (see FIG. 1). Examples of the external devices of the terminal 10 include the terminal 20, the terminal 30, the server 40, and the operation device 50. The communication unit 14 transmits the voice data and the control data generated by the control unit 12 to the server 40, or receives the voice data and the control data from the server 40. The communication unit 14 is a portion that communicates with the operation device 50. The communication unit 14 receives the motion data from the operation device 50.

The terminal 10 includes an output unit 15. The output unit 15 outputs a video of the virtual space R. The video of the virtual space R is a video based on the video data of the virtual space R generated by the control unit 12.

### <Configuration of Server>

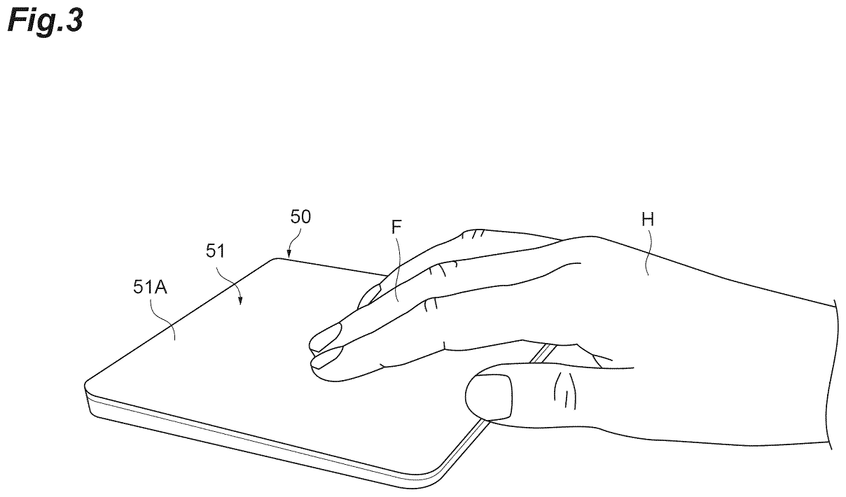

The server 40 includes a control unit 42. The control unit 42 controls the operation of the server 40. The server 40 includes a storage unit 43. The storage unit 43 is a portion that stores information necessary for controlling the server 40. FIG. 3 illustrates a server program 43P and received data 43S as information stored in the storage unit 43. The server program 43P is a program for operating the server 40, and operates a computer so that the control unit 42 executes control or the like. The received data 43S is data sent from the terminal 10, the terminal 20, and the terminal 30 to the server 40, and may include control data generated by the terminal 10, the terminal 20, and the terminal 30.

The server 40 includes a communication unit 44. The communication unit 44 is a portion that communicates with external devices of the server 40 through the network N (see FIG. 1). Examples of the external devices of the server 40 include the terminal 10, the terminal 20, and the terminal 30. The communication unit 44 receives control data for the user U1, control data for the user U2, and control data for the user U3 from the terminal 10, the terminal 20, and the terminal 30, respectively, or transmits control data generated by the terminal 10, the terminal 20, and the terminal 30 to the terminal 10, the terminal 20, and the terminal 30, respectively.

### <Hardware Configuration>

An example of the hardware configuration for each functional part of the terminal 10 and the server 40 will be described. The communication unit 44 of the server 40 can be configured using a network card or a wireless communication device so as to able to access the network N. The control unit 42 of the server 40 can be configured using a processor such as a central processing unit (CPU) or a graphics processing unit (GPU), a clock, and a built-in memory. The control unit 42 may be configured as a single piece of hardware (system on a chip (SoC)) in which a processor, a clock, a built-in memory, the storage unit 43, and the communication unit 44 are integrated. The control unit 42 operates on the basis of the server program 43P to cause a server computer to operate as the server 40. The storage unit 43 of the server 40 can be configured using a nonvolatile storage medium such as a flash memory, a hard disk, or a solid state disk (SSD).

The input unit 11 of the terminal 10 can be configured using a microphone, a camera, or the like. The microphone is used to acquire a voice of the user U1. That is, the microphone is a type of voice sensor that acquires a voice. The camera is used to acquire an image of the user U1. That is, the camera is a type of image sensor that acquires an image. Further, the input unit 11 may also be configured using operation devices of a keyboard, a mouse, and a touch panel. The control unit 12 of the terminal 10 can be configured similarly to the control unit 42 of the server 40. The control unit 12 operates on the basis of the terminal program 13P to cause a general-purpose computer to operate as the terminal 10. The storage unit 13 of the terminal 10 can be configured similarly to the storage unit 43 of the server 40. The communication unit 14 of the terminal 10 can be configured similarly to the communication unit 44 of the server 40. The output unit 15 of the terminal 10 can be configured using a display device such as a liquid crystal panel or an organic EL panel (which may be a touch panel). Further, the output unit 15 may also be configured using a speaker.

### <Configuration of Operation Device>

FIG. 3 is a perspective view of the operation device 50. FIG. 3 is a diagram illustrating a state in which the operation device 50 is operated by the fingers F of the users U1, U2, and U3. The operation device 50 is a device which is operated by the users U1, U2, and U3. The ear animation E operates in response to the operation of the operation device 50 performed by the users U1, U2, and U3. The operation device 50 is a touch pad. Examples of the type of touch pad capable of being adopted include a capacitance type, a pressure-sensitive touch type, an ultrasonic type, and the like.

The operation device 50 includes a main body 51 as a hardware configuration. The main body 51 has an operation surface 51A. The operation device 50 is operated by the fingers F of the hands H of the users U1, U2, and U3. The operation device 50 may be provided as a stand-alone device, or may be provided as a part of a remote control for operating a television display or the like. That is, the operation device 50 may be a part of the device.

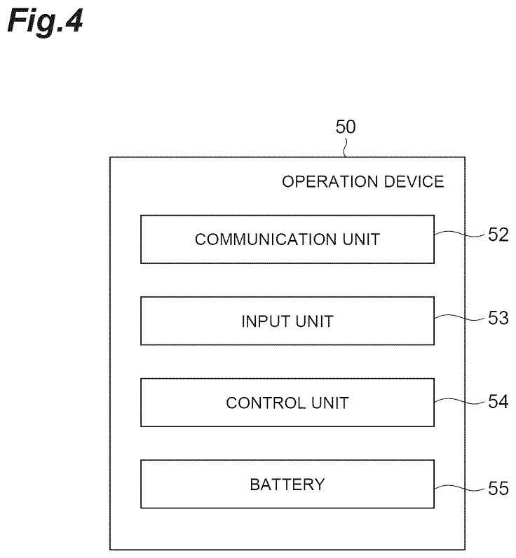

FIG. 4 is a diagram illustrating an example of a functional block of the operation device 50. As shown in FIG. 4, the operation device 50 includes a communication unit 52. The communication unit 52 is a portion that communicates with an external device through wireless communication or cable communication. Examples of the wireless communication include LAN, Bluetooth (registered trademark), Wifi, and the like. Examples of the external device include the terminal 10, the terminal 20, and the terminal 30. The communication unit 52 transmits the motion data output from a control unit 54 to the terminal 10, the terminal 20, and the terminal 30.

The operation device 50 includes an input unit 53. The input unit 53 is a portion that inputs the motions of the users U1, U2, and U3 on the operation surface 51A. The input unit 53 detects operations (gestures) on the operation surface 51A performed by the users U1, U2, and U3. Examples of the operations include clicking, tapping, sliding, scrolling, and the like. The input unit 53 outputs an operation signal to the control unit 54.

The operation device 50 includes the control unit 54. The control unit 54 generates motion data on the basis of the operation signal of the input unit 53. The control unit 54 outputs the motion data to the communication unit 52.

The control unit 54 can be configured using a processor such as a CPU or a GPU, a clock, and a built-in memory. The control unit 54 may be configured as a single piece of hardware (SoC) in which a processor, a clock, a built-in memory, and the communication unit 52 are integrated.

The operation device 50 includes a battery 55. The battery 55 supplies electric power to each unit of the operation device 50.

Next, a description will be given of the operation of the operation device 50 performed by the users U1, U2, and U3 in a case where the ear animation E of the character C is operated as, for example, “nodding,” “agreement,” “praise (clap),” “question,” “raising hand,” or “surprise.” That is, the relationship between the motion of the ear animation E of the character C and the motions of the users U1, U2, and U3 detected by the operation device 50 will be described. The motion of the ear animation E and the motions of the fingers F of the users U1, U2, and U3 for operating the ear animation E are similar (related) to each other. For example, in a case where the ear animation E of “nodding” is operated, a motion similar to the nodding motion is performed by the finger F on the operation surface 51A of the operation device 50. That is, the users U1, U2, and U3 can operate the ear animation E by performing a motion similar to the ear animation E desired to be operated in the operation device 50.

FIG. 5 is a diagram illustrating an example of motions of the ear animation E. The pattern A in FIG. 5 shows the ear animation E in a normal time.

The pattern B in FIG. 5 shows a motion of “nodding” in the ear animation E. As shown in the pattern B of FIG. 5, in the motion of “nodding,” the upper halves of the ears are bent forward in the ear animation E of the character C. In a case where the ear animation E is caused to execute the motion of “nodding,” the users U1, U2, and U3 touch the operation surface 51A of the main body 51 of the operation device 50 with two fingers F (for example, the index finger and the middle finger). Alternatively, the users U1, U2, and U3 slide the two fingers F with the two fingers F touching the operation surface 51A. The amount of sliding of the finger F is, for example, 1 cm to 2 cm.

In a case where the above motion is performed, the operation device 50 detects the motion in the input unit 53 and transmits it as motion data to the terminals 10, 20, and 30. The control unit 12 of the terminals 10, 20, and 30 generates control data for operating the ear animation E as “nodding” on the basis of the motion data.

The pattern C in FIG. 5 shows a motion of “agreement” in the ear animation E. In the motion of “agreement,” the ears are bent entirely forward in the ear animation E of the character C. In a case where the ear animation E is caused to execute the motion of “agreement,” the users U1, U2, and U3 slide two fingers F (for example, the index finger and the middle finger) with the two fingers F touching the operation surface 51A. The amount of sliding of the finger F is, for example, longer than 2 cm, and is, for example, 3 cm to 4 cm. That is, in a case where the ear animation E is caused to execute the motion of “agreement,” the users U1, U2, and U3 slide their fingers F longer than in a case where the ear animation E is caused to execute the motion of “nodding.”

In a case where the above motion is performed, the operation device 50 detects the motion in the input unit 53 and transmits it as motion data to the terminals 10, 20, and 30. The control unit 12 of the terminals 10, 20, and 30 generates control data for operating the ear animation E as “agreement” on the basis of the motion data.

The pattern D in FIG. 5 shows a motion of “clap (praise)” in the ear animation E. In the motion of “clap (praise),” the ears move closer together or farther apart in the ear animation E of the character C. In a case where the ear animation E is caused to execute the motion of “clap (praise),” the users U1, U2, and U3 bring two fingers F (for example, the thumb and the index finger, or the index finger and the middle finger) close to each other or moving them apart from each other with the two fingers F touching the operation surface 51A.

In a case where the above motion is performed, the operation device 50 detects the motion in the input unit 53 and transmits it as motion data to the terminals 10, 20, and 30. The control unit 12 of the terminals 10, 20, and 30 generates control data for operating the ear animation E as “clap (praise)” on the basis of the motion data. The control unit 12 of the terminals 10, 20, and 30 may generate control data to clap multiple times with respect to motion data relating to a single motion of bringing the two fingers F close to each other or moving them apart from each other.

The pattern E in FIG. 5 shows a motion of “question” in the ear animation E. In the motion of “question,” the ears are tangled in the ear animation E of the character C. In a case where the ear animation E is caused to execute the motion of “question,” the users U1, U2, and U3 slide two fingers F (for example, the index finger and the middle finger) in a circular (semicircular) motion with the two fingers touching the operation surface 51A. Meanwhile, in a case where the ear animation E is caused to execute the motion of “question,” the users U1, U2, and U3 may slide two fingers F(for example, the index finger and the middle finger) to draw o (infinity) with the two fingers touching the operation surface 51A.

In a case where the above motion is performed, the operation device 50 detects the motion in the input unit 53 and transmits it as motion data to the terminals 10, 20, and 30. The control unit 12 of the terminals 10, 20, and 30 generates control data for operating the ear animation E as “question” on the basis of the motion data.

The pattern F in FIG. 5 shows a motion of “raising hand” in the ear animation E. In the motion of “raising hand,” the ear stretches in the ear animation E of the character C. In a case where the ear animation E is caused to execute the motion of “raising hand,” the users U1, U2, and U3 slides only one finger F (the middle finger) upward with two fingers F (for example, the index finger and the middle finger) touching the operation surface 51A.

In a case where the above motion is performed, the operation device 50 detects the motion in the input unit 53 and transmits it as motion data to the terminals 10, 20, and 30. The control unit 12 of the terminals 10, 20, and 30 generates control data for operating the ear animation E as “raising hand” on the basis of the motion data.

The pattern G in FIG. 5 shows a motion of “surprise” in the ear animation E. In the motion of “surprise,” the tips of the ears becomes larger in the ear animation E of the character C. In this case, the body B of the character C bends backward. In a case where the ear animation E is caused to execute the motion of “surprise,” the users U1, U2, and U3 move two fingers F (for example, the index finger and the middle finger) apart from each other while sliding the two fingers F upward with the two fingers touching the operation surface 51A.

In a case where the above motion is performed, the operation device 50 detects the motion in the input unit 53 and transmits it as motion data to the terminals 10, 20, and 30. The control unit 12 of the terminals 10, 20, and 30 generates control data for operating the ear animation E as “surprise” on the basis of the motion data.

### <Method of Operating Motion of Ear Animation>

Next, a method of operating the motion of the ear animation E of the character C will be described. In a case where the ear animation E is operated, the users U1, U2, and U3 perform, for example, the motions corresponding to any of the pattern B in FIG. 5, the pattern C in FIG. 5, the pattern D in FIG. 5, the pattern E in FIG. 5, the pattern F in FIG. 5, or the pattern G in FIG. 5. Thereby, the motion data is generated in the operation device 50. The operation device 50 transmits the motion data to the terminals 10, 20, and 30.

When the motion data is received, the terminals 10, 20, and 30 generates control data corresponding to the motion data. This causes the ear animation E of the character C to perform any of the following motions in the virtual space R of the terminals 10, 20, and 30: “nodding,” “agreement,” “praise (clap),” “question,” “raising hand,” or “surprise.” In this manner, the motion of the ear animation E of the character C is operated by the users U1, U2, and U3 operating the operation device 50.

### <Method of Communication>

A method of conversation (dialogue) between characters C in the virtual space R will be described. First, the virtual space R will be described. There can be a plurality of characters C in the virtual space R. The virtual space R is, for example, a metaverse or the like. There may be various objects and the like in the virtual space R in addition to the character C. In the virtual space R, background music (BGM) may be playing, or announcements (guidance) or the like may be made. The background music (BGM) and announcements may be changed depending on the position of the character C. In the virtual space R, various activities can be performed. Examples of the activities include lectures, speeches, training, conferences, reports, counseling, consultation, entertainment, sightseeing, and the like.

In the virtual space R, the character C can be placed on a moving stage (object) S. That is, the character C can ride on the moving stage S. The moving stage S is displayed integrally with one or a plurality of characters C. The moving stage S forms an independent region in which the character C is located. The independent region is a region that can be distinguished from others. That is, the region of a certain moving stage S (hereinafter also referred to as a “first moving stage S”) and the region of another moving stage S (hereinafter also referred to as a “second the moving stage S”), which is different therefrom, are independent of each other. This makes it possible to recognize at a glance that a certain character C rides on the first moving stage S, and that another character C rides on the second the moving stage S which is different from the first moving stage S. Meanwhile, an independent region may include a plurality of portions.

The character C is located on the moving stage S. The moving stage S is provided movably in the virtual space R. The moving stage S can have its moving direction and speed operated by a user. That is, the user can move the moving stage S to any position. In a case where a plurality of characters C ride on the moving stage S, a cockpit may be provided on the moving stage S so that the user of the character C located in the cockpit can preferentially operate the moving stage S. The moving stage S may be moved by autopilot. In this case, the moving stage S may move automatically, for example, along a set route, or may move automatically to a set destination. In addition, the user can arbitrarily change the display viewpoint. For example, the viewpoint can be rotated in 3D.

One or a plurality of characters C can be placed on the moving stage S. The moving stage S may change in size depending on the number of characters C placed thereon. Specifically, the moving stage S may, for example, become larger in size as the number of characters C to be placed increases, and may become smaller in size as the number of characters C to be placed decreases. The moving stage S may change in size stepwise, or may change in size continuously (gradually) as the number of people to be placed increase or decreases. Meanwhile, the size, design, and the like of the moving stage S can be set appropriately by a user. The moving stage S can be provided with identification information, text information, and the like.

Next, an example of a method of starting a conversation between a character C1 (any character among one or a plurality of characters C) and a character C2 (another character different from the character C1) will be described with reference to FIG. 6. The users of the character C1 can be users U1, U2, and U3. The users of the character C2 can be the users U1, U2, and U3, AI. Hereinafter, for example, a form in which the user of the character C1 is the user U1 and the user of the character C2 is the user U2 will be described as an example.

In the example shown in FIG. 6, the character C1 rides on the moving stage S, and the character C2 rides on the moving stage S. In the state shown in FIG. 6, the character C1 and the character C2 cannot communicate with each other. That is, the character C1 and the character C2 cannot converse with each other. In the state shown in FIG. 6, each of the character C1 and the character C2 can hear background music (BGM), announcements, and the like which are playing in the virtual space R.

In a case where the character C1 requests a conversation to the character C2, a consent process for confirming whether the character C2 is available for a conversation is performed. The consent process is performed in a case where an operation for associating the character C1 with the character C2 is accepted. In the present embodiment, the operation of associating the character C1 with the character C2 is an operation of dragging and dropping the character C1 onto the moving stage S of the character C2.

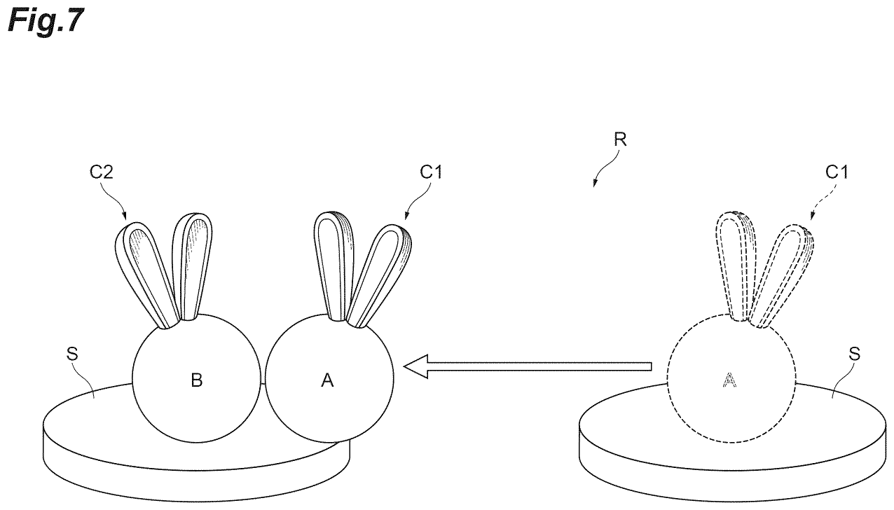

In the consent process, as shown in FIG. 7, when the character C1 is dragged and dropped onto the moving stage S of the character C2, a message for conversation consent is automatically transmitted to the user U2 of the character C2. The message can include, for example, text including content such as “May I speak now?” and user information (such as, for example, a name or a user name) that can specify the character C1.

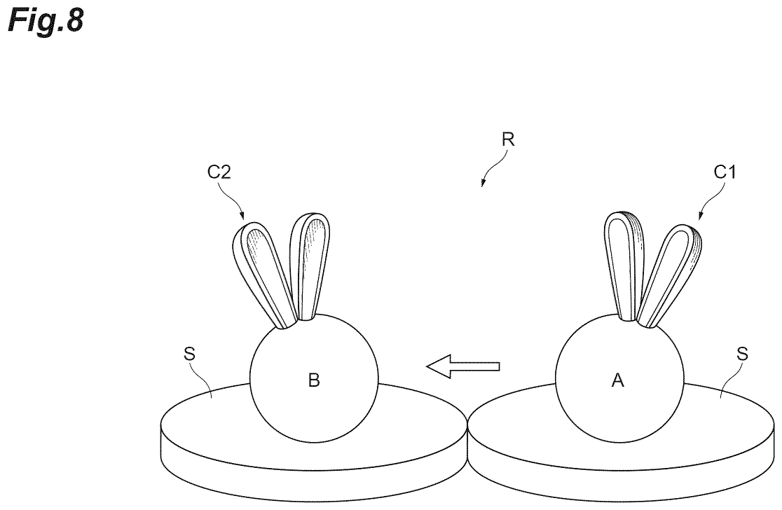

Meanwhile, the character C1 may be dragged and dropped onto the character C2, or the moving stage S on which the character C1 is located may be dragged and dropped onto the character C2 or the moving stage S on which the character C2 is located. In addition, as shown in FIG. 6, the operation of associating the character C1 with the character C2 may be performed in a state where the moving stage S on which the character C1 is located and the moving stage S on which the character C2 is located are separated from each other. As shown in FIG. 8, an operation of associating the character C1 with the character C2 may be performed in a state where the moving stage S on which the character C1 is located and the moving stage S on which the character C2 is located are close to (in contact with) each other.

When a message of conversation consent is transmitted to the character C2, the message is displayed on the screen of the user U2 of the character C2. The message display screen displays the above text and user information, and displays an “OK button” for consenting to the conversation and an “NG button” for rejecting the conversation. When the user of the character C2 selects the “NG button,” the screen of the user U1 of the character C1 displays the content that there is no consent to the conversation. Examples of display include “I'm sorry, but I have something to do,” “I am not available until ∘∘ o'clock,” “I will be available from ∘∘ o'clock,” and the like. The content of the message to be transmitted when the NG button is selected can be appropriately set by the user. In a case where the user of the character C2 selects the “NG button,” the operation of dragging and dropping the character C1 onto the moving stage S of the character C2 becomes invalid (is invalidated).

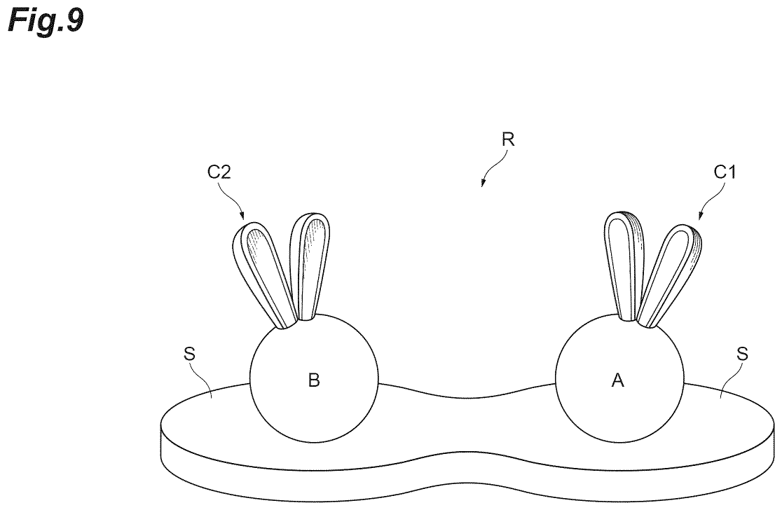

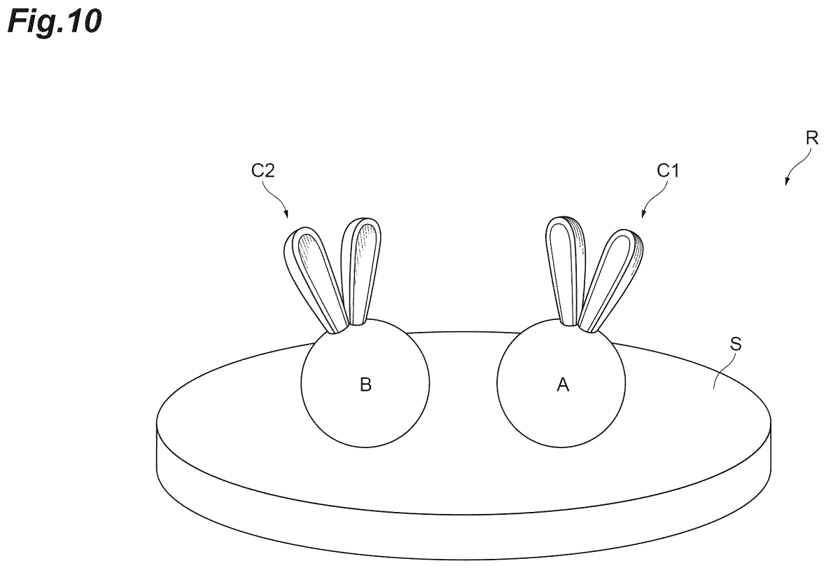

When the user U2 of the character C2 selects the “OK button,” an animation showing the process of the moving stage S on which the character C1 is located and the moving stage S on which the character C2 is located being combined into one is executed as shown in FIG. 9, and one moving stage S is displayed as shown in FIG. 10. That is, the moving stage S of the character C1 and the moving stage S of the character C2 are integrated. The moving stage S has its size changed in accordance with the number of characters C located thereon. Specifically, the moving stage S on which the two characters C1 and C2 ride becomes larger than the moving stages S on which the characters C1 and C2 ride. Meanwhile, the animation shown in FIG. 9 does not have to be executed, and may transition from the state shown in FIG. 6 or 7 to the state shown in FIG. 10.

The character C1 and the character C2 are located on the same moving stage S. The character C1 and the character C2 are located on one moving stage S. In the moving stage S, the character C1 and the character C2 can converse with each other. That is, a conversation is made possible (a conversation is established) between a plurality of characters C1 and C2 located on one (same) moving stage S. The conversation between the character C1 and the character C2 on the moving stage S cannot be heard by characters located outside the moving stage S. On the moving stage S, announcements and the like which are played in the virtual space R can be heard.

The volume of the conversation within the moving stage S can be appropriately set. The volume of the conversation can also be adjusted so that some sound leaks outside the moving stage S. In this case, it is easier to create a natural atmosphere, such as the appearance of a conversation, than in a case where there is no voice at all. Instead of a voice, a changing sound linked to the voice may be emitted.

Meanwhile, a function of contacting the characters C1 and C2 from outside the moving stage S may be provided. For example, a user outside the moving stage S may be able to make voice calls and WEB communication (such as email or chat) with the characters C1 and C2 riding on the moving stage S. For example, voice calls and the like can also be performed in units of characters, or can be performed in units of moving stages. To make a voice call to a character, the call is made to a number or the like set for each character. To make a voice call to a station, the call is made to the stage number set for each moving stage. The users of the characters C1 and C2 can notify a specific user of the stage number.

In the above form, when the character C1 is dragged and dropped onto the moving stage S of the character C2, a message for conversation consent is automatically transmitted to the user U2 of the character C2, but when the user U1 of the character C1 clicks on the character C2 who is a conversation target, a message for conversation consent may be automatically transmitted to the user U2 of the character C2. In addition, when the character C2 is clicked, a function selection window is displayed, and a message may be transmitted to the character C2 by selecting (clicking) the function “transmit consent message” displayed in the function selection window. In this case, when the user U2 of the character C2 consents to the conversation and then the character C1 is dragged and dropped onto the moving stage S of the character C2, the moving stage S on which the characters C1 and C2 ride is displayed.

In addition, in a case where communication (such as a conference schedule) is set in advance between the character C1 and the character C2, the consent process may be omitted. In this case, when the character C1 is dragged and dropped onto the moving stage S of the character C2, the moving stage S on which the characters C1 and C2 ride is displayed, and the character C1 and the character C2 can converse with each other.

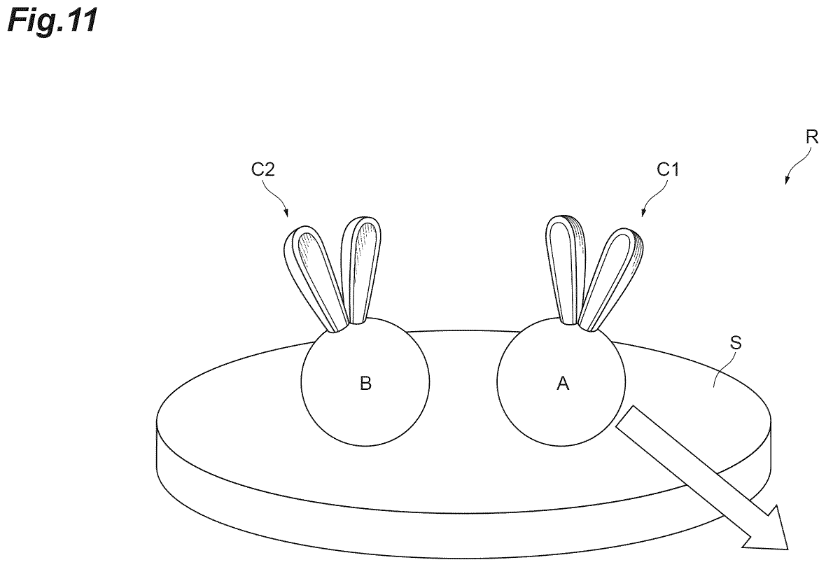

In a case where the conversation between the character C1 and the character C2 is ended, the user U1 performs an operation of ending the conversation. In the present embodiment, the operation of ending the conversation is an operation of dragging and dropping the character C outside the moving stage S. Specifically, as shown in FIG. 11, the user U1 drags and drops, for example, the character C1 outside the moving stage S. Thereby, the moving stage S is newly displayed, and the character C1 is located on the moving stage S (see FIG. 6). In this state, the character C1 and the character C2 cannot communicate with each other. That is, the character C1 and the character C2 cannot converse with each other. With the above, the conversation between the character C1 and the character C2 ends.

In addition, the conversation between the character C1 and the character C2 may end automatically on the basis of a time set in advance. The time set in advance may be a time which is arbitrarily set, or may be a time which is set by a timer. In a case where the time set in advance has elapsed, the state shown in FIG. 11 automatically transitions to the state shown in FIG. 6. That is, two moving stages S are displayed, and the characters C1 and C2 are located on each of the two moving stages S. Alternatively, the characters C1 and C2 automatically move to a meeting place (which may be a moving stage S where a plurality of characters C gather, or may be any place in the virtual space R). This ends the conversation between the character C1 and the character C2. In addition, the conversation between the character C1 and the character C2 may be ended by the administrator (the administrator of the virtual space R). In this case as well, the state shown in FIG. 11 may automatically transition to the state shown in FIG. 6, or the characters C1 and C2 may automatically move to the meeting place.

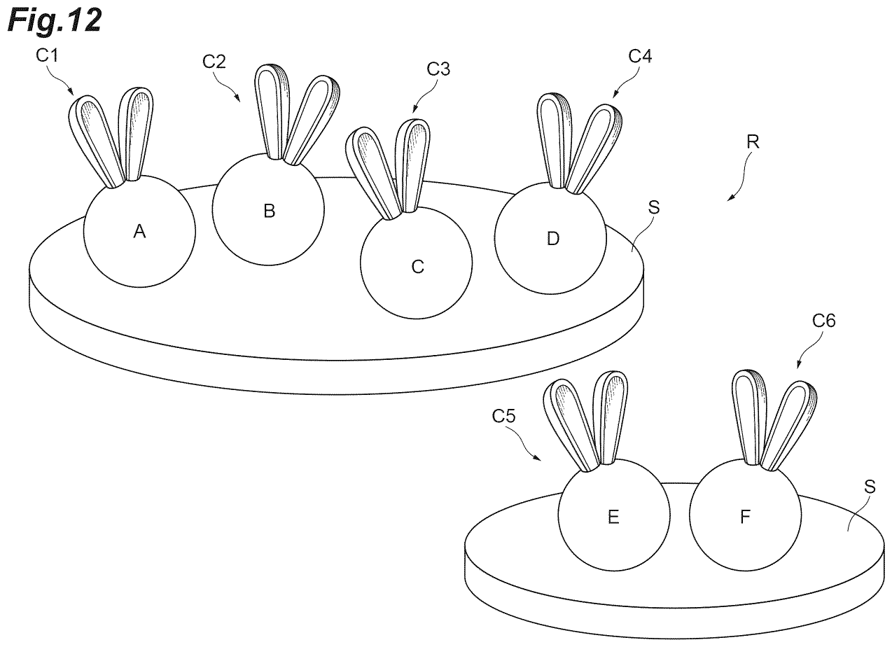

Next, a case where a plurality of characters C ride on the moving stage S and the plurality of characters C request a conversation together will be described. In the example shown in FIG. 12, characters C1, C2, C3, and C4 ride on any one moving stage S, and characters C5 and C6 ride on another moving stage S different from the one moving stage S. The characters C1, C2, C3, and C4 constitute group 1. The characters C5 and C6 constitute group 2. A case where group 2 requests a conversation with group 1 will be described below.

In each of group 1 and group 2, an administrator is set. The administrator has the authority to collectively perform control related to the conversations of the group. The administrator has the authority to operate the moving stage S. The administrator can set to one or a plurality of users. Here, an example in which the administrator of group 1 is the character C1 and the administrator of group 2 is the character C5 will be described.

In a case where group 2 requests a conversation with group 1, a consent process for confirming whether group 1 is available for a conversation is performed. In the consent process, when the character C5 who is an administrator is dragged and dropped onto the moving stage S of group 1, a message for conversation consent is automatically transmitted to the user of the character C1 who is the administrator of group 1.

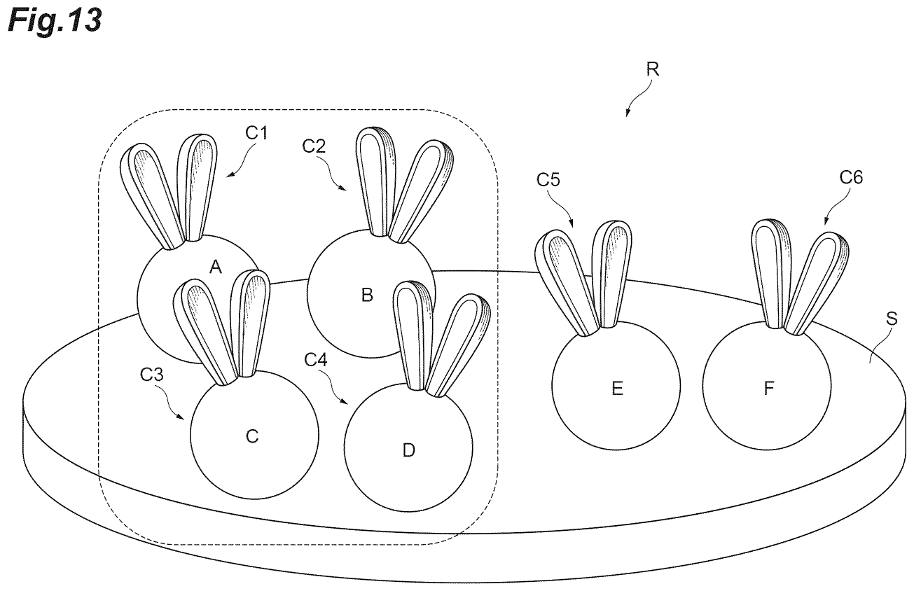

When the user of the character C1 selects the “NG button,” the screen of the user of the character C5 displays the content that there is no consent to the conversation. When the user of the character C1 selects the “OK button,” one moving stage S is displayed as shown in FIG. 13. That is, the moving stage S of group 1 and the moving stage S of group 2 are integrated.

The characters C1, C2, C3, C4, C5, and C6 are located on the same moving stage S. The characters C1, C2, C3, C4, C5, and C6 are located on one moving stage S. In the moving stage S, a conversation is possible between the characters C1, C2, C3, C4, C5, and C6. That is, a conversation is made possible (a conversation is established) between a plurality of characters C1, C2, C3, C4, C5, and C6 located on one moving stage S. In the moving stage S, all of the characters C1, C2, C3, C4, C5, and C6 can converse with each other, or the individual characters C1, C2, C3, C4, C5, and C6 (for example, the character C1 and the character C2, the character C3 and the character C4, the character C5 and the character C6) can converse with each other.

Next, a case where a conversation is ended in a group will be described. In a case where a conversation is ended in units of groups, for example, the user of the character C1 who is the administrator of group 1 surrounds the characters C1, C2, C3, and C4 so as to include the characters C1, C2, C3, and C4 which are members of group 1 as shown in FIG. 13. This causes the characters C1, C2, C3, and C4 to be surrounded by, for example, dashed lines. The user of the character C1 drags and drops the portion surrounded by the dashed lines to the outside of the moving stage S. Thereby, the moving stage S is newly displayed, and the characters C1, C2, C3, and C4 of group 1 are located on the moving stage S. That is, as shown in FIG. 12, the characters C1, C2, C3, and C4 ride on any one moving stage S, and the characters C5 and C6 ride on another moving stage S different from the one moving stage S. With the above, the conversation between group 1 and group 2 ends.

Meanwhile, the members of group 1 may be designated by clicking on and selecting the characters C1, C2, C3, and C4 or by inputting information capable of specifying the characters C1, C2, C3, and C4 on a predetermined screen without being limited to the above method.

In the state shown in FIG. 13, in a case where a conversation is ended in units of characters, for example, the user of the character C1 drags and drops the character C1 to the outside of the moving stage S. Thereby, the moving stage S is newly displayed, the character C1 is located on any one moving stage S, and the characters C2, C3, C4, C5, and C6 are located on another moving stage S different from the one moving stage S. In this state, the character C1 and the characters C2, C3, C4, C5, and C6 cannot communicate with each other. That is, the character C1 and the characters C2, C3, C4, C5, and C6 cannot converse with each other. With the above, the conversation ends.

Meanwhile, as in the above case, the conversation between group 1 and group 2 may be automatically ended on the basis of a time set in advance, or may be ended by an administrator.

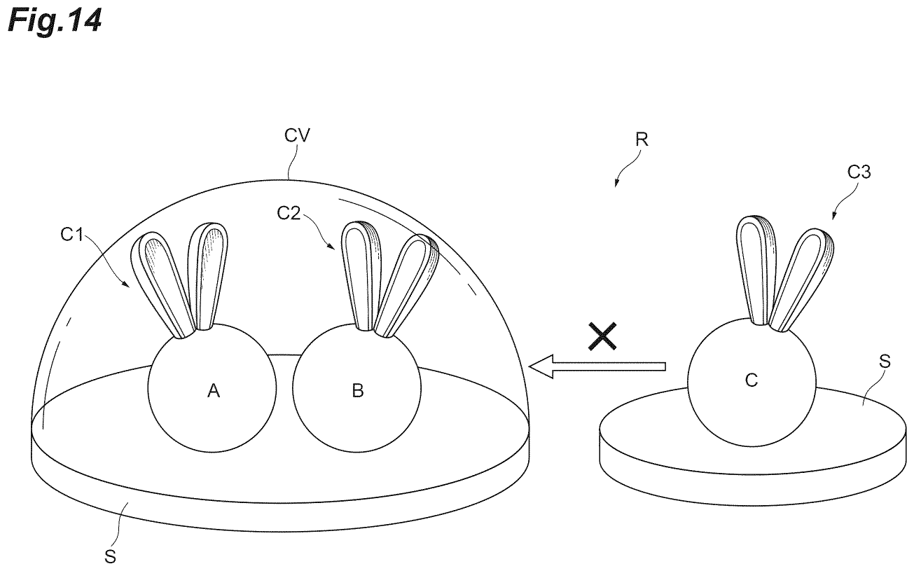

As shown in FIG. 14, a cover CV can be set on the moving stage S. The cover CV is provided on the moving stage S so as to cover, for example, the characters C1 and C2. The cover CV can have its size changed in accordance with the size of the moving stage S. The cover CV has, for example, a hemispherical shape. The cover CV may be transparent, may be semi-transparent, or may not be transparent. In the example shown in FIG. 14, the cover CV is transparent.

The cover CV is information related to a conversation on the moving stage S. The cover CV has a function of informing the outside world of the status of participation in a conversation. The information related to a conversation is information indicating whether participation in the conversation is possible, information indicating the degree of possibility of participation in the conversation, or the like. In the present embodiment, the information related to the conversation is information indicating whether participation in the conversation is possible. In the present embodiment, in a case where the cover CV is displayed, it basically indicates that participation in the conversation is not possible. Depending on the transparency, color, and the like of the cover CV, it is possible to inform users around the moving stage S of the degree to which they can participate in the conversation on the moving stage S (the state inside the moving stage S). For example, in a case where the cover CV is transparent, a conversation request can indicate that it is possible to participate in the conversation. In a case where the cover CV is not transparent (in a case where it is opaque), it can clearly indicate that participation in the conversation from the outside is being refused (rejected). In addition, depending on the degree to which the cover CV is transparent (transparent, semi-transparent, opaque, or the like), the degree of availability for participation in the conversation can be indicated in stages.

The cover CV can be set to be displayed or not displayed by a user. As shown in FIG. 14, in a case where a plurality of the characters C1 and C2 ride on the moving stage S, a user who is set as an administrator may set whether to display or not to display the cover CV. The cover CV indicates that only authorized users can participate in the conversation. In a case where the cover CV is displayed, as shown in FIG. 12, the drag and drop is rejected even if the user of the character C drags and drops the character C3 onto the moving stage S of the characters C1 and C2.

In a case where the cover CV is set on the moving stage S, it may be possible to make contact with the characters C1 and C2 within the cover CV. For example, in a case where a conference is being held on the moving stage S, the user of the character C who participates in the conference late can make voice calls or perform WEB communication with users or the entire group riding on the moving stage S. This allows the cover CV not to be displayed temporarily by the users of the characters C1 and C2 riding on the moving stage S, making it possible to, for example, drag and drop the character C3 onto the moving stage S. Meanwhile, in a case where the cover CV is opaque, it can also be set to reject contact from the outside.

In addition, the necessity for the consent process may be set by displaying or not displaying the cover CV (according to the presence or absence of the cover CV). Specifically, it is possible to set that the consent process is required in a case where the cover CV is displayed, and that the consent process is not in a case where the cover CV is not displayed.

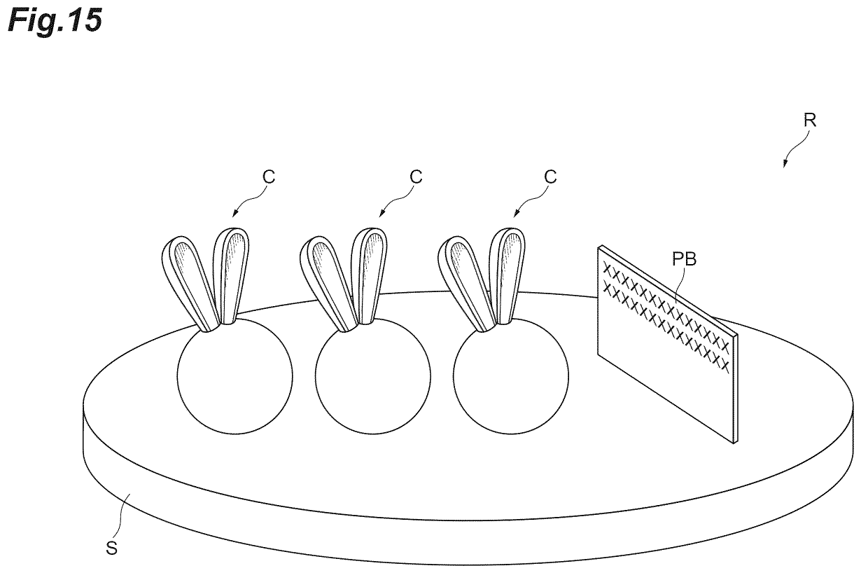

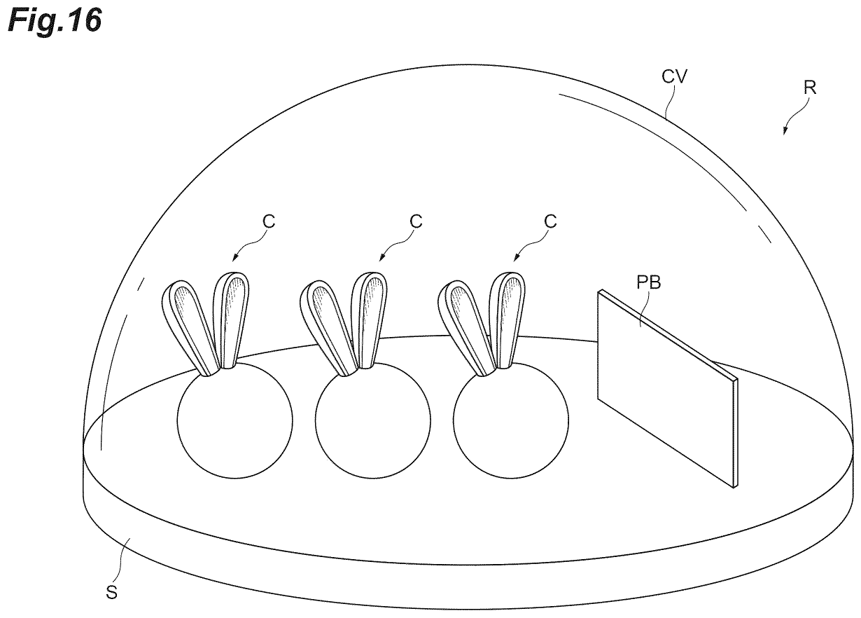

In addition, as shown in FIG. 15, in a case where the moving stage S is provided with an object having a display function, for example, a projector board PB, and a case where the cover CV is not displayed, text, images, and the like displayed on the projector board PB may be made visible from outside the moving stage S. As shown in FIG. 16, in a case where the cover CV is displayed, text and the like displayed on the projector board PB may be made invisible from outside the moving stage S. In the example shown in FIG. 16, the cover CV is transparent, and the character C located on the moving stage S can be visually recognized from the outside, but the text and the like displayed on the projector board PB cannot be visually recognized (is not displayed). In this case, in a case where the cover CV is displayed, the character C located on the moving stage S can be confirmed from the outside, while the content of display on the projector board PB cannot be confirmed from the outside. Thereby, for example, in a case where a conference is being held on the moving stage S, the participants and situation of the conference can be confirmed from the outside, but the content of the conference cannot be confirmed from the outside.

Meanwhile, the projector board PB in a case where the cover CV is displayed may not be displayed, or may be displayed with a blur or the like. In short, it is only necessary that the content displayed on the projector board PB cannot be recognized (understood) by the moving stage S from the outside.

### Effects

As described above, in the system 100 according to the present embodiment, in a case where a plurality of characters C are located on one moving stage S, the characters C can converse with each other. That is, a conversation is established between the characters C located on one moving stage S. Therefore, it is possible to ascertain at a glance which characters C are conversing with each other. In other words, it is possible to ascertain at a glance which the character C is not conversing. In this way, the system 100 makes it possible to visualize the state of communication. Therefore, the system 100 makes it possible to offer casual chatting to the character C, for example, in a case where no communication is taking place. Therefore, casual chatting and the like can be naturally generated in the system 100. As a result, in the system 100, communication between the characters C can be easily generated in the virtual space R.

In the system 100 according to the present embodiment, in a case where an operation of dragging and dropping any character C out of one or a plurality of characters C or the moving stage S on which the character C is located onto another character C or the moving stage S on which the character C is located is accepted, the moving stage S on which any character C has been located and the moving stage S on which another character C has been located are integrated, and any character C and another character C are positioned on the integrated single moving stage S. In this configuration, a plurality of characters C can be positioned on one moving stage S by a simple drag-and-drop operation. In addition, the sense of unity of conversation is improved by integrating the moving stage S. Further, by providing a drag-and-drop participation transition process, a user who operates the character C can prepare himself or herself mentally, making it possible to feel more natural.

In the system 100 according to the present embodiment, in a case where the above drag-and-drop operation is accepted, a screen is displayed for the user of the other character C to select whether to permit a conversation; in a case where the user of the other character C permits the conversation, the moving stage S on which any character C is located and the moving stage S on which the other character C has been located are integrated, and any character C and the other character C are positioned on the integrated single moving stage S; and in a case where the user of the other character C rejects the conversation, the above drag-and-drop operation is invalidated. In this configuration, the user of the character C can select whether to have a conversation.

Although the embodiment of the present disclosure has been described above, the present disclosure is not necessarily limited to the above-described embodiment, and various modifications are possible without departing from the spirit and scope of the present disclosure.

In the above embodiment, a form in which the ear animation E is operated in any of “nodding,” “agreement,” “praise (clap),” “question,” “raising hand,” or “surprise” has been described as an example. However, the motion of the ear animation E in response to the user's motion is not limited to this. The motion of the ear animation E may be other motions, or may further include other motions. The bending angle and speed of the ear animation E can be set (changed) appropriately. This makes it possible to express subtle emotions, and to adjust (enhance or weaken) the intensity of the emotional expression. In a case where the intensity of the motion is set to be strong in the ear animation E, for example, the expression of nonverbal information of a person who has difficulty expressing emotions can be assisted by expressing the content, intensity, and speed of the motion of the ear animation E. In addition, even for communication between cultures with different nonverbal information expressions, it is also possible to perform setting for converting a motion form according to the cultures of the users U1, U2, and U3.

In the above embodiment, a form in which the motions of the hands H or fingers F of the users U1, U2, and U3 are detected by the operation device 50 has been described as an example. However, the hands H or fingers F of the users U1, U2, and U3 may be detected by an image sensor (a camera, a laser, or the like).

In addition, the motion of the ear animation E is basically executed on the basis of the motions of the users U1, U2, and U3, but the facial expressions of the users U1, U2, and U3 (facial recognition performed by a camera), the voices of the users U1, U2, and U3, expression control based on artificial intelligence (AI), and the like may be used in combination. The motion of the ear animation E may be controlled by selecting the motion of the character C in an operation window displayed on the screen.

In the above embodiment, the operation device need only be a device capable of detecting acceleration and angular velocity. The operation device may be, for example, a cellular phone (such as a smartphone) having a display (display unit) that displays the ear animation E. In the case of a cellular phone, the motion data is generated by operating the cellular phone in the same manner as the operation device 50.

In the above embodiment, a form in which the control data is generated in the terminal 10, the terminal 20, and the terminal 30 has been described as an example. However, the control data may be generated by the server 40. In this configuration, the terminal 10, the terminal 20, and the terminal 30 transmit the motion data to the server 40, and the server 40 generates the control data on the basis of the motion data.

In the above embodiment, a form in which the body B, the ear animation E, and the like are displayed on the terminals 10, 20, and 30 has been described as an example. However, in a case where the terminal is a wearable terminal or a head mounted display (HMD) terminal, the body B, the ear animation E, and the like may be displayed on a lens or the like, or may be displayed as a hologram. That is, the character C is displayed in cyberspace. Cyberspace can include virtual reality (VR), augmented reality (AR), and mixed reality (MR).

In the above embodiment, a form in which the character C having the ear animation E is used in the virtual space R has been described as an example. However, the form of the character is not limited to this. The character may be an avatar. The avatar may include facial expressions, or may not include facial expressions. The avatar may have the ear animation E.

The character C may be deformed. For example, a display unit or the like may be displayed on the body B of the character C. The display unit may display conversation text obtained by converting the voice of the character C into text, a translation of the conversation text, a translation of the display content of the display unit, and the like. In addition, the display unit may display at least one of necessary diagrams, sentences, music, videos, still images, and sites by using AI based on at least one of the voice and text input of the character C.

In the above embodiment, a form in which the character C rides on the moving stage S has been described as an example. However, the object that forms a region in which the character C is located is not limited to the moving stage S. For example, the object that forms a region in which the character C is located may be a simple disk, a flying carpet, a spaceship, a airship, a large bus, a flying classroom, or the like.

In addition, the object may be a band-like object that surrounds the character C. In this case, the character C being located on an object means that the character C is located within a band-like object.

In the above embodiment, a form in which the character C is operated by the operation of the operation device 50 has been described as an example. However, the motion of the character C may be operated using other methods. For example, the states of the users U1, U2, and U3 may be acquired and controlled on the basis of the states.

In the above embodiment, a form in which the operation of associating the character C1 with the character C2 is an operation of dragging and dropping the character C1 onto the moving stage S of the character C2 has been described as an example. However, the operation of associating the characters C with each other is not limited to the drag-and-drop operation. For example, in a case where the character C1 and the character C2 are associated with each other, the association operation may be an operation in which the user of the character C1 selects (clicks or the like) the character C2, may be an operation in which the user of the character C1 selects the character C2 in a predetermined selection screen, or may be an operation in which the user of the character C1 inputs information for specifying the character C2, or the like. In short, the association operation need only be an operation in which the user of the character C1 can specify the character C2 who is a conversation partner (target).

In the above embodiment, a form in which, when a message of conversation consent is transmitted to the character C who is a conversation partner in the consent process, a message is displayed on the screen of the user of the character C, and the user selects whether to permit a conversation on the message screen has been described as an example. However, the choice of whether to permit the conversation may be made by the user's voice (“permit,” “OK,” “not permit,” “NG,” or the like).

In the above embodiment, a form in which the operation of ending a conversation between the characters C is an operation of dragging and dropping the character C to the outside of the moving stage S has been described as an example. However, the operation of ending a conversation is not limited to the drag-and-drop operation. For example, the operation of ending a conversation may be an operation of selecting an item for ending the conversation on a predetermined screen (such as a menu screen), or may be an operation of clicking an “×” mark displayed on a part of the character C. In short, the operation of ending the conversation need only be an operation in which the user of the character who ends the conversation indicates his/her intention to end the conversation.

In the above embodiment, a form in which the cover CV has a hemispherical shape has been described as an example. However, the shape of the cover CV is not limited to this. In addition, the cover CV has been described as an example of information related to participation in the conversation on the moving stage S. However, the information related to participation in the conversation on the moving stage S is not limited to this.

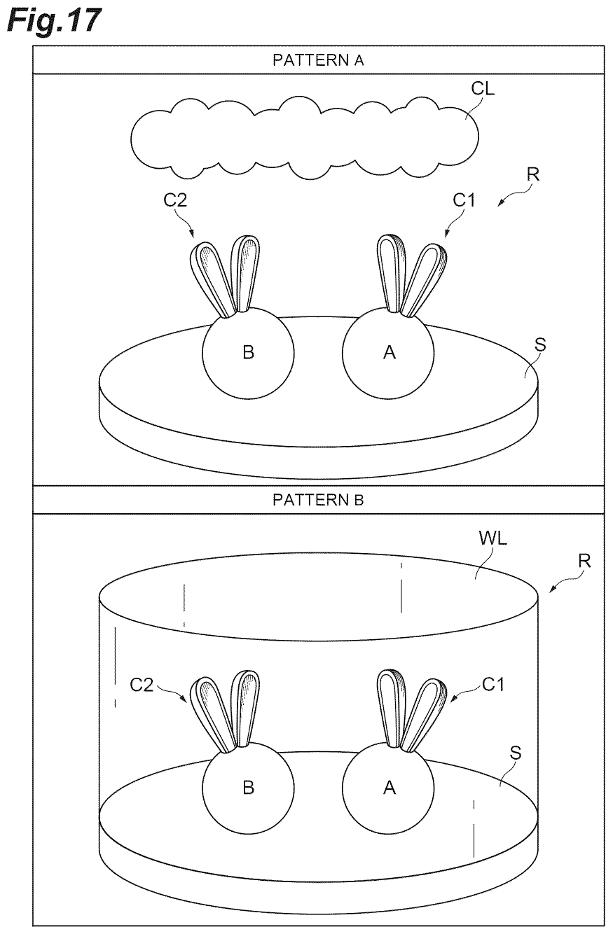

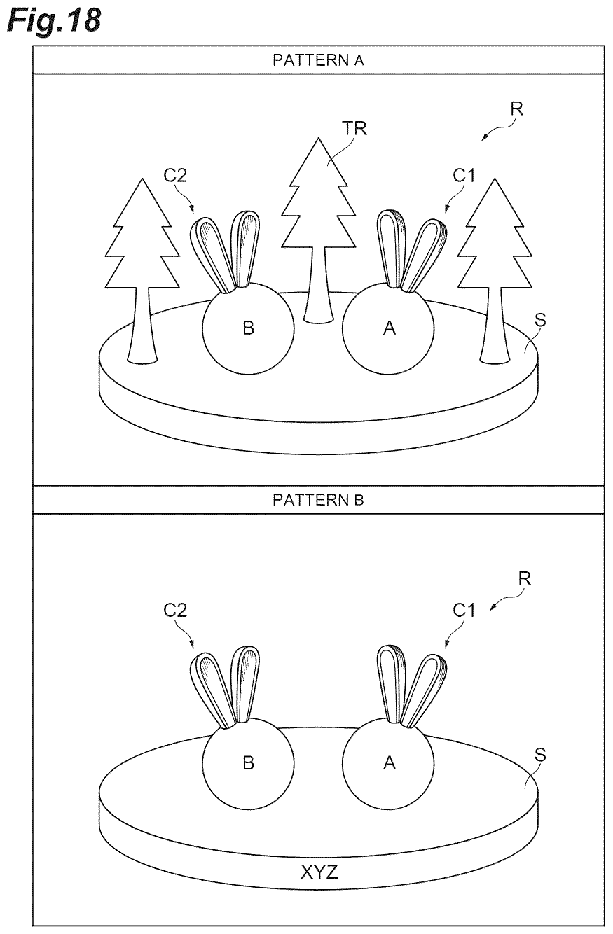

For example, the information related to participation in the conversation may be a cloud CL displayed above the character C as shown in a pattern A of FIG. 17, or may be a wall-like member WL placed on the periphery of the moving stage S as shown in a pattern B of FIG. 17. The member WL may be transparent or may be opaque. In addition, the information related to participation in the conversation may be something like a plantation constituted by one or a plurality of trees TR as shown in a pattern A of FIG. 18. In addition, the information related to participation in the conversation may be an animal (such as a bird) displayed above the character C, may be something like a curtain, or may be something like a mist.

As shown in a pattern B of FIG. 18, the information may be information indicating a specific group such as “XYZ” displayed on the moving stage S. In this case, the display of “XYZ” can suggest to the outside world that the participation of users other than users related to “XYZ” is rejected (they are asked to refrain from participating). In addition, in a case where the user is related to “XYZ,” that is, in a case where information related to “XYZ” is set in the user's attribute information, participation in the conversation may be permitted. In other words, in a case where the information related to “XYZ” is not set in the user's attribute information, participation in the conversation may be rejected. Even in a case where the information related to “XYZ” is not set in the user's attribute information, participation in the conversation may be permitted when permitted by the character C located on the moving stage S.

In the above embodiment, a form in which, in a case where an operation of dragging and dropping any character C or the moving stage S on which the character C is located onto another character C or the moving stage S on which the character C is located is accepted, the moving stage S on which any character C has been located and the moving stage S on which the other character C has been located are integrated, and any character C and the other character C are positioned on the integrated single moving stage S has been described as an example. However, the process of positioning any character C and the other character C on one moving stage S may be performed automatically.

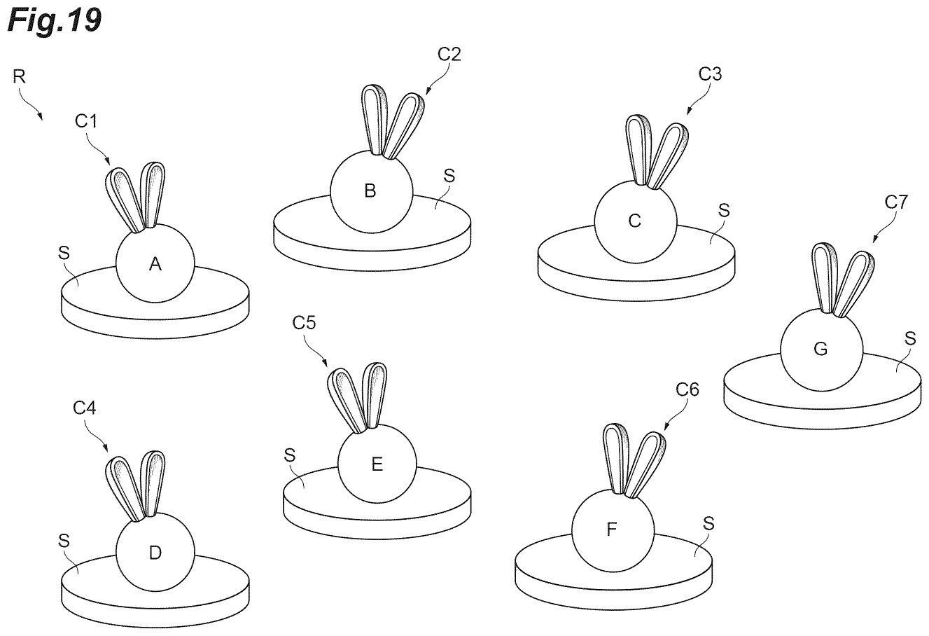

An example of how the character C automatically starts a conversation will be described with reference to FIG. 19. In the example shown in FIG. 19, the character C1, the character C2, the character C3, the character C4, the character C5, and the character C6 each ride on the moving stage S in the virtual space R. The users of the character C1, the character C2, the character C3, the character C4, the character C5, and the character C6 can be the users U1, U2, and U3. At least one of the character C1, the character C2, the character C3, the character C4, the character C5, and the character C6 may be an AI user.

The virtual space R is used for meetings where a plurality of characters gather to converse (such as conferences, training sessions, exchange meetings, or social gatherings), and the like. A conversation between characters in the virtual space R is managed by an administrator. The administrator can set the duration of the meeting, the duration of one conversation, the number of people to talk, and the like. The duration of one conversation time can be set to, for example, 3 to 4 minutes. The number of people to talk is not limited, but may be set to, for example, two people.

In the virtual space R, for example, there may be the character C1, the character C2, the character C3, the character C4, the character C5, and the character C6 who are permitted to participate by the administrator. For example, the users of the characters C1 to C6 apply in advance to the administrator for participation, and in a case where the administrator permits their participation, they receive a URL or the like related to their participation transmitted by the administrator. The users of the characters C1 to C6 can enter the virtual space R by participating through the URL at a predetermined date and time.

In the situation shown in FIG. 19 (before the conversation starts), the administrator may provide a lecture on how to proceed with the conversation, or the like. For example, an overview of the conversation time, or the like is provided. In addition, the administrator may provide a lecture on how to conduct the conversation. For example, an explanation of how to conduct a conversation may be given, such as first introducing oneself by giving his/her name, then talking about a topic, and the like. In addition, an explanation may be given on how to listen to a story when a conversation is performed (such as, for example, nodding while repeating words, expressing surprise, or listening while praising). During a lecture performed by the administrator, questions and the like may be accepted from the users of the characters C1 to C6.

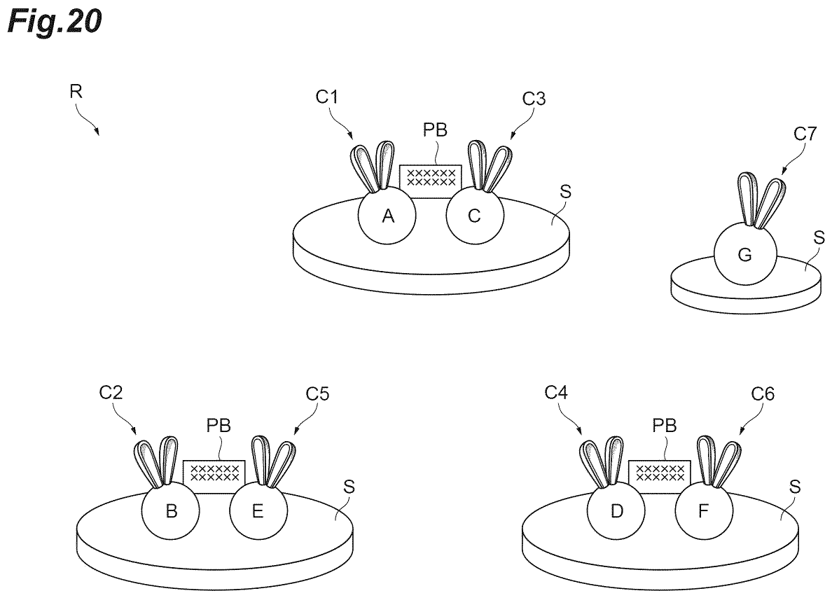

When an operation of starting a conversation is performed by the administrator, two characters are automatically located on one moving stage S as shown in FIG. 20. That is, the two characters are automatically matched. In the example shown in FIG. 20, the character C1 and the character C3 are located on the same moving stage S, the character C2 and the character C5 are located the same moving stage S, and the character C4 and the character C6 are located on the same moving stage S. The characters located on the moving stage S may be selected by the administrator, or may be selected randomly. It is preferable that the characters located on the moving stage S be set so as not to be matched with characters that have been matched in the past. That is, it is preferable that the matching partner be set to a different character each time.

A character C7 may exist in the virtual space R. The character C7 is operated by, for example, a facilitator user. The user of the character C7 may be an administrator.

A conversation between the character C1 and the character C3, a conversation between the character C2 and the character C5, and a conversation between the character C4 and the character C6 on the moving stage S cannot be heard by characters located outside the moving stage S. Announcements of the character C7 and the like can be heard on each moving stage S. The user of the character C7 may be able to hear the conversations on all the moving stages S. That is, the user of the character C7 may be able to monitor all the moving stages S. In addition, the user of the character C7 may be able to record the conversations and the like on all the moving stages S.

As shown in FIG. 20, the moving stage S may be provided with a projector board (display unit) PB. The projector board PB may display the theme of the conversation (information related to the content of the conversation) or the like. The projector board PB may display, for example, favorite foods, favorite places, things to do, favorite activities (hobbies), desired items, and the like. In addition, the projector board PB may display a translation of the conversation between characters. Meanwhile, in a case where the projector board PB is not provided, the theme of the conversation and the like may be announced. In addition, the moving stage S may display a clock, a timer, and the like. In the case of the timer, the remaining time of the conversation is displayed. In addition, an alarm may be set to sound in a case where the remaining time reaches a predetermined time (for example, before 10 seconds).

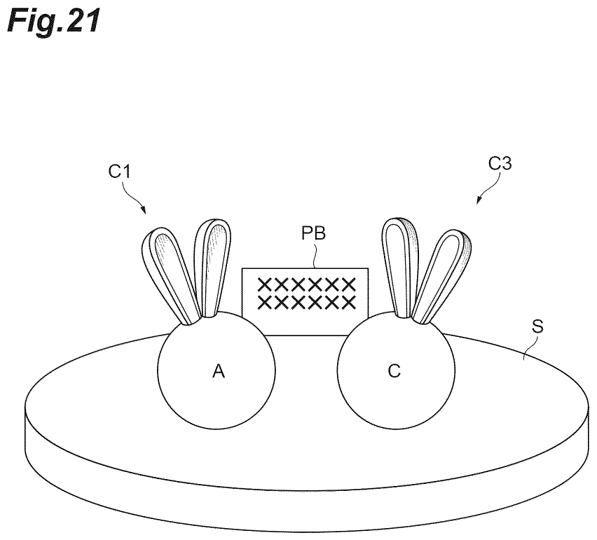

As shown in FIG. 21, for example, only the moving stage S on which the character C1 and the character C3 are located may be displayed on the display screen of the user of the character C1 and the user of the character C3. The user can switch between the screens displayed. By performing a predetermined operation, the user can display a screen (full screen) on which all the characters C1 to C7 (the moving stage S) are displayed as shown in FIG. 20, or can display a screen (individual screen) on which only the user's character and the opponent's character are displayed as shown in FIG. 21.

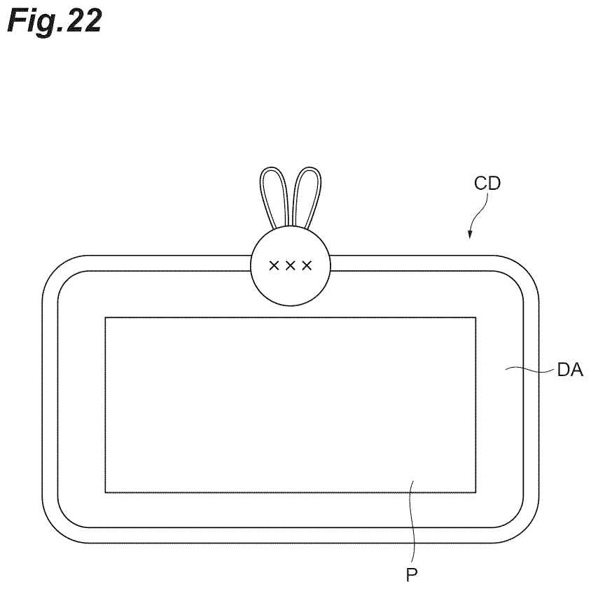

The characters C1 to C6 can hand over a card CD as shown in FIG. 22 to their conversation partner. The users of the characters C1 to C6 can hand over the card CD to the conversation partner by performing a predetermined operation (such as, for example, selecting a card transmission item on the operation screen). The card CD is created in advance by the users of the characters C1 to C6.

The card CD contains at least information with which it is possible to identify the user of the character. For example, the character is displayed on the card CD. For example, text can be displayed on the character. Examples of the text that can be displayed include a name, a nickname, identification information, and the like. A facial photograph or the like may be displayed on the character. In addition, an image P can be displayed in a display area DA of the card CD. The display area DA can also be used to display a message, embed music, or display a video. The received card CD is automatically stored. The stored card CD can be viewed. By clicking on the card CD, the user of the card CD may be able to be contacted (a message creation screen can be displayed).

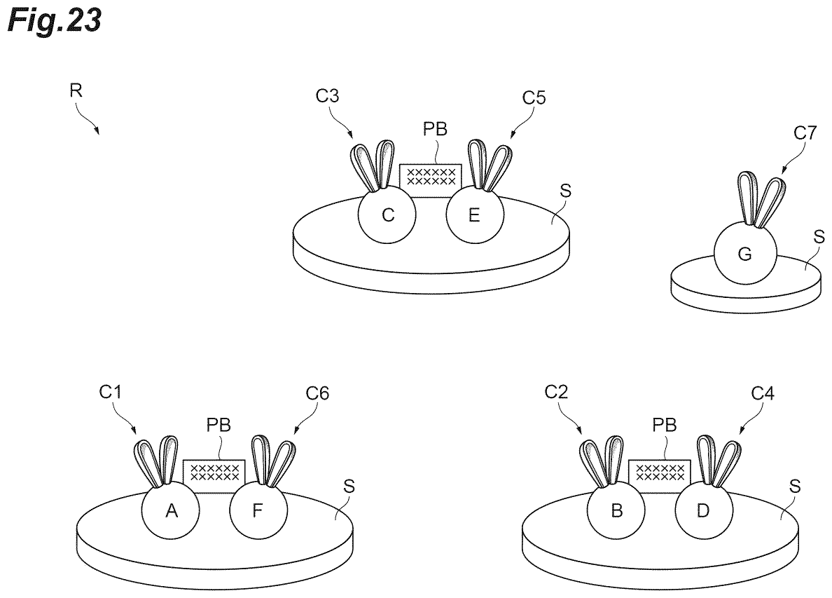

When a predetermined time has elapsed since the conversation started in the state shown in FIG. 20, the state automatically returns to the state shown in FIG. 19 once, and then the conversation partner is automatically changed as shown in FIG. 23. That is, in a case where a predetermined time has elapsed in a state where a plurality of characters are located on one moving stage S (the state shown in FIG. 20), the moving stage S is newly displayed and the character who has ended the conversation is positioned on the newly displayed moving stage S (the state shown in FIG. 19). Thereafter, as shown in FIG. 23, two new characters are automatically positioned on one moving stage S.

In the example shown in FIG. 23, the character C3 and the character C5 are located on the same moving stage S, the character C1 and the character C6 are located on the same moving stage S, and the character C2 and the character C4 are located on the same moving stage S. That is, they are matched with a different character from the previous time.

When a predetermined time has elapsed since the conversation started in the state shown in FIG. 23, the state automatically returns to the state shown in FIG. 19 once as described above, and then the conversation partner is automatically changed. This process is performed multiple times within a period of time (for example, 30 minutes) set by the administrator. When the period of time set by the administrator arrives, the state returns to the state shown in FIG. 19.

In the above configuration, the moving stage S on which any character has been located and the moving stage S on which the other character has been located are automatically integrated, and any character and the other character are positioned on the integrated single moving stage S. In this configuration, a plurality of characters can be automatically positioned on one moving stage S. That is, the characters can be matched automatically. This makes it possible to not only communicate with a specific character (user), but also communicate with a new character. Therefore, a sense of intimacy can be improved by coming into contact with a new personality of a user with whom there has been no communication so far. Therefore, subsequent communication becomes easier, psychological safety improves, improvements in creativity, productivity, or the like can be expected.

In addition, in a case where a predetermined time has elapsed in a state where a plurality of characters are located on one moving stage S, the moving stage S is newly displayed and one or a plurality of characters who have ended their conversation are positioned on the newly displayed moving stage S. In this configuration, the conversation is forcibly ended after a predetermined time has elapsed. In this manner, the period of time of communication is not limited, and thus communication with the same character does not drag on for too long. This makes it possible to communicate with many characters.

In addition, the projector board PB that displays information related to the content of the conversation is caused to display on one moving stage S on which a plurality of characters are located. In this configuration, the topic of the conversation is displayed (provided) on the projector board PB, and thus communication can be performed smoothly and efficiently within a limited time. This makes it possible to efficiently perform a conversation touching on the personality of the user of the character.

In addition, information related to a predetermined time may be displayed on one moving stage S on which a plurality of characters are located. In this configuration, for example, the remaining time of a predetermined time or the like can be confirmed, which makes it possible to carry out communication in consideration of time allocation (end time).

In addition, a character operated by the facilitator user may be displayed in the virtual space R. In this configuration, in a case where the program is applied to meetings in which many users participate (such as, for example, training sessions, information exchange meetings, or social gatherings), the meetings will be conducted by a facilitator, which makes it possible for the meetings to proceed smoothly.

In addition, in a state where a plurality of characters are located on one moving stage S, it is possible to exchange cards CD that contain at least information with which it is possible to identify the user of the character. In this configuration, after the conversation ends, it is possible to confirm a character (user) with whom the conversation has taken place.

Meanwhile, in the above form, a form in which two characters are located on one moving stage S has been described as an example, but the number of characters located on one moving stage S may be three or more. The number of characters can be set appropriately by the administrator.

### REFERENCE SIGNS LIST

10 Terminal, 11 Input unit, 12 Control unit, 13 Storage unit, 13P Terminal program, 14 Communication unit, 15 Output unit, 20 Terminal, 30 Terminal, 40 Server, 42 Control unit, 43 Storage unit, 43P Server program, 43S Received data, 44 Communication unit, 50 Operation device, 51A Operation surface, 52 Communication unit, 53 Input unit, 54 Control unit, 55 Battery, 100 System, AP Access point, B Body, BS Base station, C Character, C1 Character (any character), C2 Character (another character), C3 Character, C4 Character, C5 Character, C6 Character, C7 Character, CD Card, CL Cloud, CV Cover, DA Display region, E Ear animation, F Finger, H Hand, N Network, P Image, PB Projector board, R Virtual space, S Moving stage, first moving stage, second moving stage, TR Tree, U1 User, U2 User, U3 User, WL Member

1. A non-transitory computer readable storage medium including executable instructions, which when executed by a computer, cause the computer to execute a communication assistance program stored on the non-transitory computer readable storage medium, the communication assistance program for assisting communication between a plurality of characters in a virtual space,
wherein an object on which one or a plurality of the characters are located is displayed integrally with one or a plurality of the characters, and
the plurality of characters located on the one object are enabled to converse with each other.

2. The storage medium according to claim 1, wherein, in a case where an operation of associating any of one or a plurality of the characters with another character different from the character is accepted, the object on which any of the characters has been located and the object on which the other character has been located are integrated, and any of the characters and the other character are positioned on the integrated single object.

3. The storage medium according to claim 2, wherein, in a case where the association operation is accepted, a user of the other character is prompted to select whether to permit a conversation,
in a case where the user of the other character permits the conversation, the object on which any of the characters has been located and the object on which the other character has been located are integrated, and any of the characters and the other character are positioned on the integrated single object, and
in a case where the user of the other character rejects the conversation, the association operation is invalidated.

4. The storage medium according to claim 2, wherein the association operation is an operation of dragging and dropping any of the characters or the object on which the character is located onto the other character or the object on which the character is located.

5. The storage medium according to claim 2, wherein, in a case where an operation of ending a conversation of one or a plurality of the characters is accepted with the plurality of characters located on the one object, the object is newly displayed and one or a plurality of the characters who have ended the conversation are positioned on the newly displayed object.

6. The storage medium according to claim 5, wherein the operation of ending the conversation is an operation of dragging and dropping one or a plurality of the characters from the object to the outside.

7. The storage medium according to claim 1, wherein the object is movable in the virtual space.

8. The storage medium according to claim 1, wherein communication between the character located on the object and the character not located on the object is enabled.

9. The storage medium according to claim 1, wherein information related to participation in a conversation is displayed on the object.

10. The storage medium according to claim 1, wherein, in a case where one or a plurality of the characters are located on the one object, the character is automatically moved to a predetermined location when a predetermined time has elapsed or a predetermined operation is accepted.

11. The storage medium according to claim 1, wherein at least one of the plurality of characters located on the one object is operated by AI.

12. The storage medium according to claim 1, wherein the object on which any of one or a plurality of the characters has been located and the object on which the other character different from the character has been located are automatically integrated, and any of the characters and the other character are positioned on the integrated single object.

13. The storage medium according to claim 12, wherein, in a case where a predetermined time has elapsed with the plurality of characters located on the one object, the object is newly displayed and one or a plurality of the characters who have ended a conversation are positioned on the newly displayed object.

14. The storage medium according to claim 12, wherein a display unit that displays information related to conversation content is caused to display in the one object on which the plurality of characters are located.

15. The storage medium according to claim 13, wherein information related to the predetermined time is displayed in the one object on which the plurality of characters are located.

16. The storage medium according to claim 12, wherein the character operated by a facilitator user is displayed in the virtual space.

17. The storage medium according to claim 12, wherein cards containing at least information with which it is possible to identify the user of the character are able to be exchanged with the plurality of characters located on the one object.

18. The storage medium according to claim 12, wherein at least one of the plurality of characters located on the one object is operated by AI.

19. A communication assistance method of assisting communication between a plurality of characters in a virtual space, the method comprising:
displaying an object on which one or a plurality of the characters are located integrally with one or a plurality of the characters; and
enabling the plurality of characters located on the one object to converse with each other.

20. A communication assistance system configured to assistance communication between a plurality of characters in a virtual space,
wherein an object on which one or a plurality of the characters are located is displayed integrally with one or a plurality of the characters, and
the plurality of characters located on the one object are enabled to converse with each other.
